(19) United States
(12) Patent Application Publication
(10) Pub. No.: US 2024/0287648 A1
(43) Pub. Date: Aug. 29, 2024

(54) LITHIUM RECOVERY FROM WASTE GLASS USING MOLTEN SALT TREATMENT

(71) Applicant: CORNING INCORPORATED, CORNING, NY (US)

(72) Inventors: David Eugene Baker, Bath, NY (US); Deqiu Fan, Painted Post, NY (US); Qiang Fu, Painted Post, NY (US); Yuhui Jin, Painted Post, NY (US); Grace MaryAlice Yu Leahy, Corning, NY (US); William James McKendrick, Painted Post, NY (US); Cedrick Alexander O’Shaughnessy, Painted Post, NY (US)

(21) Appl. No.: 18/582,791

(22) Filed: Feb. 21, 2024

Related U.S. Application Data
(60) Provisional application No. 63/487,196, filed on Feb. 27, 2023.

(51) Int. Cl. C22B 26/12; C22B 7/00; H01M 10/54

(52) U.S. Cl. CPC C22B 26/12; C22B 7/001; H01M 10/54

(57) ABSTRACT

A method for extracting lithium metal ions from glass includes contacting the glass with a molten salt bath for a duration of time, wherein the glass includes lithium and the contacting the glass with the molten salt bath for the duration of time extracts at least 40% of the lithium metal ions from the glass. The method further includes removing residual solids from the molten salt bath, wherein the residual solids include residual glass having a reduced concentration of lithium. The method further includes precipitating lithium metal ions from the molten salt bath to produce a solid precipitated lithium salt and separating the precipitated lithium salt from the molten salt bath.

This application claims the benefit of priority under 35 U.S.C. § 119 of U.S. Provisional Application Ser. No. 63/487,196 filed on Feb. 27, 2023, the content of which is relied upon and incorporated herein by reference in its entirety.

### BACKGROUND

### Field

The present specification generally relates to glass, and particularly to methods of recovering lithium from waste glass.

### Technical Background

Lithium presents the highest sublimation energy, electronegativity, and ionization energy and the smallest ionic radius of the alkali group metals, which makes lithium a desirable option for the cathode material for rechargeable high-power-density batteries. The high usage of electric cars and lithium batteries consumes the majority of the lithium raw material supply. After batteries, the glass and ceramic industries are the second largest consumers of lithium. Lithium-containing glasses offer high ion diffusivity and ion exchange capability. Ion-exchanged (chemically strengthened) lithium glasses possess good drop performance and mechanical properties. Such glass is widely used as mobile electronic cover glasses. However, the variable availability and high cost of lithium raw materials is of concern.

The cover glass manufacturing processes, such as cutting and finishing, produces large amounts of lithium containing glass waste. Recycling these glasses by extracting and reusing the lithium can greatly help the current material shortage situation and can reduce the environmental impact from waste glass disposal.

### SUMMARY

A first aspect of the present disclosure may be directed to a method of recovering lithium from waste glass. The method may comprise contacting the glass with a molten salt bath for a duration of time, wherein the glass comprises lithium, and the contacting the glass with the molten salt bath for the duration of time may extract at least 40% of the lithium metal ions from the glass; removing residual solids from the molten salt bath, wherein the residual solids may comprise residual glass having a reduced concentration of lithium; precipitating lithium metal ions from the molten salt bath to produce a solid precipitated lithium salt; and separating the precipitated lithium salt from the molten salt bath.

A second aspect may include the first aspect, wherein the contacting the glass with the molten salt bath for a duration of time further may comprise maintaining the molten salt bath at a fixed temperature of from about 450° C. to about 600° C.

A third aspect may include the first or second aspect, wherein a lithium metal ion extraction efficiency may be greater than or equal to 40%.

A fourth aspect may include any one of the first through third aspects, wherein the residual solids, after removal from the molten salt bath, may have a lithium content that is less than 50% of the lithium content in the glass before contacting with the molten salt bath.

A fifth aspect may include any one of the first through fourth aspects, wherein the glass may comprise glass sheets, and the glass sheets have a thickness of from about 5 μm to about 1 mm.

A sixth aspect may include any one of the first through fourth aspects, further comprising crushing the glass to produce glass particles prior to contacting the glass with the molten salt bath.

A seventh aspect may include the sixth aspect, wherein the glass particles may have a median particle size of from about 2 μm to about 1 mm.

An eighth aspect may include any one of the first through seventh aspects, further comprising, after removing the residual solids from the molten salt bath, actively cooling the residual solids, wherein actively cooling the residual solids may reduce diffusion of lithium ions back into the residual solids.

A ninth aspect may include the eighth aspect, wherein actively cooling the residual solids may comprise directing a cooling medium, such as air or water, at or through the residual solids.

A tenth aspect may include any one of the first through ninth, further comprising, after removing the residual solids from the molten salt bath, contacting the residual solids with a buffering bath.

An eleventh aspect may include the tenth aspect, wherein prior to contacting the residual solids with the buffering bath, the buffering bath may comprise from about 0 ppm to about 500 ppm of lithium metal ions.

A twelfth aspect may include the eleventh aspect, wherein the contacting the residual solids with the buffering bath may extract residual lithium metal ions from the residual solids into the buffering bath.

A thirteenth aspect may include the twelfth aspect, further comprising precipitating lithium metal ions from the buffering bath to produce a precipitated lithium salt and separating the precipitated lithium salt from the buffering bath.

A fourteenth aspect may include any one of the first through thirteenth aspects, wherein the molten salt bath may comprise a salt-to-glass weight ratio of greater than or equal to 1:1 and less than or equal to 10:1 and the method further may comprise quenching the molten salt bath and the residual solids within the molten salt bath before removing the residual solids from the molten salt bath.

A fifteenth aspect may include the fourteenth aspect, wherein quenching the molten salt bath and the residual solids may comprise contacting with a cooling fluid until the temperature of the molten salt bath is reduced to less than 150° C. or less than 120° C.

A sixteenth aspect may include any one of the first through fifteenth aspects, wherein contacting the glass with the molten salt bath may extract less than or equal to 5%, or less than or equal to 1%, of each species other than lithium from the glass.

A seventeenth aspect may include any one of the first through sixteenth aspects, wherein, prior to contact with the molten salt bath, the glass may comprise: from 30 mol % to 85 mol % SiO₂; from 2 mol % to 30 mol % Al₂O₃; from 0 mol % to 20 mol % B₂O₃; from 2 mol % to 20 mol % LiO₂; from 0 mol % to 20 mol % Na₂O; from 0 mol % to 20 mol % K₂O; from 0 mol % to 20 mol % MgO; from 0 mol % to 20 mol % CaO; from 0 mol % to 10 mol % SrO; from 0 mol % to 10 mol % BaO; from 0 mol % to 5 mol % ZrO₂; from 0 mol % to 5 mol % Ti₂O; and from 0 mol % to 5 mol % Sn₂O.

An eighteenth aspect may include any one of the first through seventeenth aspects, wherein prior to contacting the glass with the molten salt bath, the molten salt bath may comprise sodium nitrate, potassium nitrate, or combinations thereof.

A nineteenth aspect may include the eighteenth aspect, wherein, prior to contacting the glass with the molten salt bath, the molten salt bath may comprise 100 wt % sodium nitrate, based on the total weight of the molten salt bath.

A twentieth aspect may include the eighteenth aspect, wherein, prior to contacting the glass with the molten salt bath, the molten salt bath may comprise from about 95 wt % to about 100 wt % sodium nitrate or potassium nitrate, based on the total weight of the molten salt bath.

A twenty-first aspect may include any one of the first through eighteenth aspects, wherein precipitating the lithium metal ions from the molten salt bath may comprise adding a precipitating reagent to the molten salt bath before contacting the glass with the molten salt bath or after removing the residual solids from the molten salt bath, wherein the precipitating reagent may cause lithium salts to precipitate out of the molten salt bath.

A twenty-second aspect may include the twenty-first aspect, wherein the precipitating reagent may comprise an alkali metal carbonate, an alkali metal phosphate, or a combination thereof.

A twenty-third aspect may include the twenty-second aspect, wherein the precipitating reagent may comprise sodium carbonate, sodium phosphate, or a combination thereof.

A twenty-fourth aspect may include the twenty-third aspect, wherein the precipitating reagent may be sodium carbonate and the lithium salt precipitated out of the molten salt bath may comprise lithium carbonate.

A twenty-fifth aspect may include the twenty-fourth aspect, wherein prior to contacting the glass with the molten salt bath, the molten salt bath may comprise from about 0.5 wt % to about 5 wt % sodium carbonate, based on the total weight of the molten salt bath.

A twenty-sixth aspect may include the twenty-fourth aspect, wherein, prior to contacting the glass with the molten salt bath, the molten salt bath may comprise about 95 wt % sodium nitrate and about 5 wt % sodium carbonate, based on the total weight of the molten salt bath.

A twenty-seventh aspect may include the twenty-second aspect, wherein the precipitating reagent is sodium phosphate and the lithium salt precipitated out of the molten salt bath may comprise lithium sodium phosphate, lithium phosphate, or combinations thereof.

A twenty-eighth aspect may include the twenty-seventh aspect, wherein, prior to contacting the glass with the molten salt bath, the molten salt bath may comprise from about 0.5 wt % to about 5 wt % sodium phosphate, based on the total weight of the molten salt bath.

A twenty-ninth aspect may include the twenty-seventh aspect, wherein, prior to contacting the glass with the molten salt bath, the molten salt bath may comprise about 98 wt % sodium nitrate and about 2 wt % sodium phosphate, based on the total weight of the molten salt bath.

A thirtieth aspect may include any one of the first through thirteenth or sixteenth through twenty-ninth aspects, wherein during contacting the glass with the molten salt bath, the molten salt bath may comprise a salt-to-glass weight ratio of greater than or equal to 2:1 and less than or equal to 17:1.

A thirty-first aspect may include the thirtieth aspect, wherein during contacting the glass with the molten salt bath, the molten salt bath may comprise a salt-to-glass weight ratio of greater than or equal to 3:1 and less than or equal to 15:1.

A thirty-second aspect may include any one of the first through thirty-first aspects, further comprising preheating the glass to a preheating temperature of from about 200° C. to about 450° C. prior to contacting the glass with the molten salt bath.

A thirty-third aspect may include the thirty-second aspect, wherein preheating the glass further may comprise maintaining the glass at the preheating temperature for a duration of time from about 5 minutes to about 30 minutes.

A thirty-fourth aspect may include any one of the first through thirty-third aspects, wherein the contacting the glass with the molten salt bath further may comprise contacting the glass with the molten salt bath for a contact duration of from about 30 minutes to about 48 hours.

A thirty-fifth aspect may include the thirty-fourth aspect, wherein the contacting the glass with the molten salt bath further may comprise contacting the glass with the molten salt bath for a contact duration of from about 1 hour to about 6 hours.

A thirty-sixth aspect may include any one of the first through thirty-fifth aspects, further comprising separating the precipitated lithium salt from the molten salt bath.

A thirty-seventh aspect may include the thirty-sixth aspect, comprising separating the precipitated lithium salt from the molten salt bath when the precipitated lithium salt occupies greater than or equal to 20 volume percent of a vessel containing the molten salt bath.

A thirty-eighth aspect may include the thirty-sixth aspect, further comprising incorporating the separated lithium salt into a molten glass comprising one or a plurality of glass constituents to produce a lithium-containing glass.

A thirty-ninth aspect may include any one of the first through thirty-eighth aspects, further comprising, after removing the residual solids from the molten salt bath, melting the residual solids and using this melted glass to make glass with little or no lithium content, wherein the glass with little or no lithium content may comprise less than about 2 wt % lithium.

A fortieth aspect may include any one of the first through thirty-ninth aspects, further comprising, after removing the residual solids from the molten salt bath, reusing the molten salt bath for a second cycle of the method recited in any one of the previous aspects.

A forty-first aspect may include any one of the first through fortieth aspects, wherein a lithium metal ion content of the molten salt bath after contacting the glass with the molten salt bath for a duration of time and before precipitating the lithium metal ions from the molten salt bath may be from 500 ppm to 5000 ppm.

A forty-second may include any one of the first through forty-first aspects, wherein the glass may comprise lithium oxide.

These and other aspects, advantages, and salient features will become apparent from the following detailed description, the accompanying drawings, and the appended claims.

### BRIEF DESCRIPTION OF THE DRAWINGS

FIG. 1 depicts a flow chart for another method of recovering lithium from waste glass, according to embodiments disclosed and described herein;

FIG. 2 depicts a flow chart for still another method of recovering lithium from waste glass, according to embodiments disclosed and described herein;

FIG. 3 depicts a flow chart for another method of recovering lithium from waste glass, according to embodiments disclosed and described herein;

FIG. 4 depicts a flow chart for a method of recovering lithium from waste glass, according to embodiments disclosed and described herein;

FIG. 5 graphically depicts the X-Ray Diffraction (XRD) plot of a lithium precipitate collected from waste glass via lithium extraction using molten salt bath treatment, according to embodiments disclosed and described herein; and

FIG. 6 graphically depicts electron microprobe analysis data collected from a glass sample after it was subjected to lithium extraction using molten salt bath treatment, according to embodiments disclosed and described herein.

### DETAILED DESCRIPTION

Reference will now be made in detail to embodiments of methods for recovering lithium from waste glass, various embodiments of which will be described herein with specific reference to the accompanying drawings. Whenever possible, the same reference numerals will be used throughout the drawings to refer to the same or like parts. In the following detailed description, numerous specific details may be set forth in order to provide a thorough understanding of embodiments described herein. However, it will be clear to one skilled in the art when embodiments may be practiced without some or all of these specific details. In other instances, well-known features or processes may not be described in detail so as not to unnecessarily obscure the disclosure. In addition, like or identical reference numerals may be used to identify common or similar elements. Moreover, unless otherwise defined, all technical and scientific terms used herein have the same meaning as commonly understood by one of ordinary skill in the art to which this disclosure belongs. In case of conflict, the present specification, including the definitions herein, will control.

Although other methods and materials can be used in the practice or testing of the embodiments, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. More specifically, the example composition ranges given herein are considered part of the specification and further, are considered to provide example numerical range endpoints, equivalent in all respects to their specific inclusion in the text, and all combinations are specifically contemplated and disclosed. Further, if there are a variety of additional steps that can be performed it is understood that each of these additional steps can be performed with any specific embodiment or combination of embodiments of the disclosed methods, and that each such combination is specifically contemplated and should be considered disclosed.

Moreover, where a range of numerical values is recited herein, comprising upper and lower values, unless otherwise stated in specific circumstances, the range is intended to include the endpoints thereof, and all integers and fractions within the range. It is not intended that the scope of the disclosure be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

It is noted that one or more of the claims may utilize the term “wherein” as a transitional phrase. For the purposes of defining the present disclosure, it is noted that this term is introduced in the claims as an open-ended transitional phrase that is used to introduce a recitation of a series of characteristics of the structure and should be interpreted in like manner as the more commonly used open-ended preamble term “comprising.”

As a result of the raw materials and/or equipment used to produce the glass compositions discussed herein, certain impurities or components that are not intentionally added, can be present in the final glass composition. Such materials are present in the glass composition in minor amounts and are referred to herein as “tramp materials.”

As used herein, a glass composition having 0 mol % or 0 wt. % of a compound is defined as meaning that the compound, molecule, or element was not purposefully added to the composition, but the composition may still comprise the compound, typically in tramp or trace amounts. Similarly, “iron-free,” “sodium-free,” “lithium-free,” “zirconium-free,” “alkali earth metal-free,” “heavy metal-free” or the like are defined to mean that the compound, molecule, or element was not purposefully added to the composition, but the composition may still comprise iron, sodium, lithium, zirconium, alkali earth metals, or heavy metals, etc., but in approximately tramp or trace amounts.

The crystalline phase assemblages and weight percentages of crystalline phases and residual glass phases are determined based on x-ray diffraction (XRD) using a Rietveld analysis. The XRD spectra were obtained using a D8 ENDEAVOR™ XRD machine available from Bruker and equipped with Cu radiation and a LynxEye detector. The Rietveld analysis based on the XRD spectra were performed using the TOPAS™ version 6 analysis software from Bruker.

Electron microprobe (EPMA) line scan analyses were performed on a JEOL JXA-8500F Hyperprobe field emission electron microprobe analyzer equipped with five wavelength dispersive spectrometers. Samples are prepared as polished cross-sections and a conductive carbon coating is evaporated on the polish surface to dissipate charging. Spatially resolved element concentrations were obtained using Probe for EPMA Extreme edition microanalysis software version 13.1.2 from Probe Software, Inc., Eugene, Oregon using time dependent intensity (TDI) correction to compensate for alkali loss during analysis. Line scan analyses were performed using a defocused beam and stepped at 50 micrometer step intervals across the diameter of the sample cross-section, transecting the thickest portion of the cross-section. Typical beam parameters used for analyses are 15 keV accelerating potential at 20-30 nA beam current with on-peak count times of 20 seconds.

Inductively Coupled Plasma Optical Emission Spectroscopy (ICP-OES) was performed on a Perkin Elmer Avio 500 DV ICP-OES. Samples were digested in a sealed bottle and heated, then fumed to dryness and re-constituted with nitric acid. Once fully digested the samples were transferred to known volumes and analyzed using an internal standard. Samples were run against a matrix matched standard and a blank.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation; and the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Directional terms as used herein—for example up, down, right, left, front, back, top, bottom, vertical, horizontal—are made only with reference to the figures as drawn and are not intended to imply absolute orientation unless otherwise expressly stated.

Any ranges used herein include all ranges and subranges and any values there between unless explicitly stated otherwise.

As previously discussed, lithium is used by the glass and glass ceramic industries, which are the second largest consumers of lithium. During the last few years, the demand for lithium for use in batteries has been increasing dramatically due to the trend of more and more electric vehicles on the market. It is projected that the total number of electric vehicles is expected to exceed 30 million by 2025. Today, most of the lithium is produced from brine, sea water, or minerals, or by recycling of spent lithium-ion batteries. The production rate of lithium has been strained due to the rising demand for lithium. As a result, the price of lithium has been increasing significantly. Given the large amount of lithium used in glass manufacturing, there is a strong demand to recycle lithium, especially from wasted glasses, for further utilization.

Waste glass (e.g., glass cullet in the glass industry) can be generated in almost every step of glass processing for making commercial glass. Waste glass recycling involves re-melting the cullet. Present methods for recycling glass cullet are sensitive to impurities and, thus, are viable only if the cullet is compositionally stable without contaminations from other sources. For instance, transition between two different types of glass is very common in production. But the chemical composition of the cullet generated during the transition lies between the starting and end glass and may not be chemically stable. Thus, re-melting such cullet as a batch raw material to produce new glass can be very challenging, as it requires waste separation and sorting.

Further, during the glass finishing stage, cutting fluids and polishing powders are usually used as coolant and polishing agents (such as cerium oxide). Thus, cullet generated from this stage can contain large amounts of organic and inorganic contaminants, which makes re-melting of such cullet directly very difficult or almost impossible. Other times, mixing the cullet with different compositions in a production environment due to poor cullet management can also make reuse very difficult. Currently, re-melting lithium containing waste glass at the post-customer stage, such as from the cover and back glasses of retired cell phones, seems almost impossible due to poor sorting and contamination. In addition, a large amount of the cullet is required to feed the melting tank and melting process. Generally, the quality or the quantity of waste glass cannot be guaranteed, leading to operational bottlenecks. Today, most cullet ends up in landfill sites.

Therefore, an ongoing need exists for methods of recovering lithium from waste glass so that the lithium can be reused in the glass making process. The present disclosure is directed to a methods for recovering lithium from waste glass by submerging the waste glass in a molten salt bath to extract lithium ions from waste glass through ion exchange, followed by precipitation of the extracted lithium as a lithium salt.

The methods disclosed herein demonstrate wide applicability in the recycling of glass containing lithium. The ion exchange using a molten salt bath to extract lithium out of the waste glass is highly selective for lithium. For instance, multivalent metal ions, such as alkaline earth metals or transition metals, are not extracted to any significant extent during the presently disclosed process. In addition, due to the high temperatures employed during extraction, the molten salt bath extraction methods disclosed herein can be used for the recycle of mixed composition glass wastes. This eliminates the need for complicated glass sorting and separation steps prior to extraction. Moreover, because the methods disclosed herein are compatible with the ion-exchange tanks currently available at existing manufacturing facilities, the methods can be readily scaled up using existing equipment.

Ion exchange can occur by subjecting a glass to an ion exchange medium having a specific composition and temperature for a specified period of time. The ion exchange medium may contain ions that are larger than lithium ions, such as sodium ions or potassium ions. When the glass is subjected to such conditions, the lithium ions present in the glass may exchange with the larger ions in the ion exchange medium (e.g., molten salt bath). In embodiments, the lithium ions in the waste glass are exchanged for the larger alkali metal ions contained in the high temperature molten salt bath.

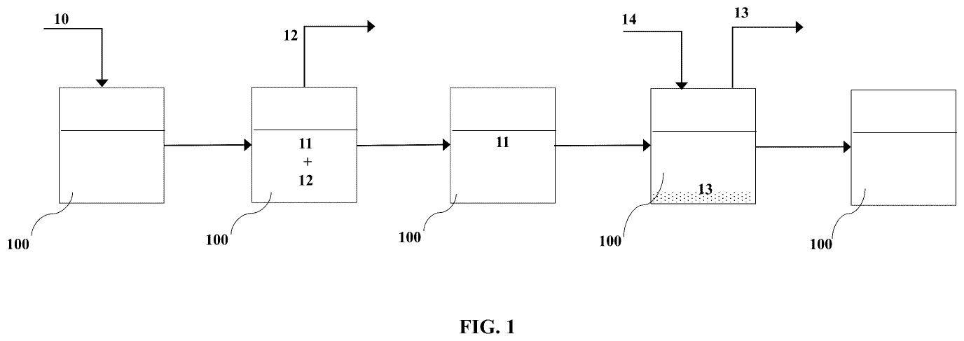

Referring now to FIG. 1, disclosed herein are methods for extracting lithium metal ions from waste glass 10 comprising lithium. The methods comprise contacting the waste glass 10 a molten salt bath 100 for a duration of time. Contacting the waste glass 10 with the molten salt bath 100 for the duration of time extracts lithium metal ions 11 from the waste glass 10 into the molten salt bath 100, and also produces residual solids 12. The residual solids 12 comprise residual waste glass having a reduced concentration of lithium. After the duration of time, the residual solids 12 are removed from the molten salt bath 100. A precipitating reagent 14 may be added to the molten salt bath 100, which may cause the lithium metal ions 11 to precipitate from the molten salt bath 100 as precipitated lithium salt 13. The precipitating reagent 14 may be added after removing the residual solids 12 from the molten salt bath 100 or may be included in the molten salt bath 100 prior to adding the waste glass 10 to the molten salt bath 100. After precipitation, the precipitated lithium salts 13 may then be separated from the molten salt bath 100.

The waste glass 10 may be made from any glass composition or combinations of glass compositions comprising lithium, such as glass compositions comprising lithium oxide. In embodiments, the glass composition of the waste glass 10 may include at least silica (SiO₂), alumina (Al₂O₃), and lithium oxide (LiO₂). The waste glass 10 composition may also include boron trioxide (B₂O₃), zirconia (ZrO₂), alkali metal oxides (e.g., Na₂O, K₂O, etc), alkaline metal oxides (e.g., MgO, CaO, SrO, BaO), titanium dioxide (TiO₂), tin oxide (SnO₂), or combinations of waste glass. In embodiments, the glass compositions may include other constituents, such as but not limited to P₂O₅, Co₃O₄, Cr₂O₃, CuO, Fe₂O₃, NiO, Sb₂O₃, ZnO, HfO₂, or combinations thereof. By way of example and not limitation, in embodiments of the process disclosed herein, the waste glass 10 may comprise one or a plurality of different glass compositions, where the glass compositions may comprise from 30 mol % to 85 mol % SiO₂, from 2 mol % to 30 mol % Al₂O₃, from 0 mol % to 20 mol % B₂O₃, from 2 mol % to 20 mol % LiO₂, from 0 mol % to 20 mol % Na₂O, from 0 mol % to 20 mol % K₂O, from 0 mol % to 20 mol % MgO, from 0 mol % to 20 mol % CaO, from 0 mol % to 10 mol % SrO, from 0 mol % to 10 mol % BaO, from 0 mol % to 5 mol % ZrO₂, from 0 mol % to 5 mol % Ti₂O, and from 0 mol % to 5 mol % Sn₂O. In embodiments, the waste glass 10 may comprise sheets having a thickness of from about 0.5 mm to about 1 mm. In embodiments, the waste glass 10 may comprise crushed glass particles having a median particle size of from about 2 μm to about 1 mm.

Prior to contacting the waste glass 10 with the molten salt bath 100, the molten salt bath 100 may comprise sodium nitrate, potassium nitrate, or combinations thereof. In embodiments, prior to contacting the waste glass 10 with the molten salt bath 100, the molten salt bath 100 may comprise 100 wt % sodium nitrate. In embodiments, prior to contacting the waste glass 10 with the molten salt bath 100, the molten salt bath 100 may comprise from about 95 wt % to about 100 wt % sodium nitrate, potassium nitrate, or both.

In embodiments, during the contacting the waste glass 10 with the molten salt bath 100, the molten salt bath 100 may comprise a salt-to-glass weight ratio of greater than or equal to 2:1 and less than or equal to 17:1. When the salt-to-glass ratio is less than 2:1, the extraction efficiency of lithium may be too low due to rapid increase in a concentration gradient of lithium between the molten salt bath 100 and the waste glass 10 after a short duration of time. In embodiments, during contacting the waste glass 10 with the molten salt bath 100, the molten salt bath 100 may comprise a salt-to-glass weight ratio of greater than or equal to 3:1 and less than or equal to 15:1, greater than or equal to 4:1 and less than or equal to 13:1, greater than or equal to 5:1 and less than or equal to 11:1, or greater than or equal to 7:1 and less than or equal to 9:1.

The waste glass 10 is contacted with the molten salt bath 100 for a duration of time. In embodiments, the waste glass 10 may be contacted with the molten salt bath 100 for a duration of time of from about 1 hour to about 48 hours, from about 3 hours to about 24 hours, from about 5 hours to about 12 hours, from about 1 hour to about 12 hours, from about 1 hour to about 8 hours, or from about 1 hour to about 6 hours. In embodiments, the waste glass 10 may be contacted with the molten salt bath 100 for a duration of from about 1 hour to about 6 hours. In embodiments, the contacting waste glass 10 with the molten salt bath 100 for a duration of time further comprises maintaining the molten salt bath 100 at a fixed temperature of from about 450° C. to about 600° C., such as from about 450° C. to about 550° C., from about 475° C. to about 600° C., from about 475° C. to about 550° C., from about 500° C. to about 600° C., or from about 500° C. to about 550° C.

Referring again to FIG. 1, at the end of the duration of time, the residual solids 12 may be removed from the molten salt bath 100. In embodiments, the residual solids 12 may have a lithium content that is less than or equal to about 50% of the lithium content in the waste glass 10 before contacting the waste glass 10 with the molten salt bath 100. In embodiments, the residual solids 12 may have a lithium content that is less than or equal to about 40%, less than or equal to about 30%, less than or equal to about 25%, less than or equal to about 20%, or even less than or equal to about 15% of the lithium content in the waste glass 10 before contacting with the molten salt bath 100. In embodiments, the residual solids 12 may be melted and used to make glass with little or no lithium content.

In embodiments, a lithium extraction efficiency of the process may be greater than or equal to about 40%, greater than or equal to about 50%, greater than or equal to about 60%, greater than or equal to about 70%, greater than or equal to about 75%, greater than or equal to about 80%, or even greater than or equal to 85%. The lithium extraction efficiency is defined as:

$$\frac{[ ( Li in the waste glass ) - ( Li in the residual solids ) ]}{( Li in the waste glass )} \times 100$$

The concentration of lithium in the waste glass 10 is known or can be measured through known techniques. The concentration of lithium in the residual solids 12 can be determined by directly measuring the concentration of lithium in the residual solids 12 or by measuring the amount of lithium salts precipitated from the molten salt bath 100 or the concentration of lithium in the molten salt bath 100 prior to precipitation and calculating the concentration of lithium in the residual solids 12 using mass balance equations.

Electron microprobe analysis may be used to measure the lithium metal ion content of the waste glass 10 prior to contact with the molten salt bath 100 and/or the lithium metal ion content of the residual solids 12 after contacting the waste glass 10 with the molten salt bath 100 for the duration of time. Ion exchange chromatography may be used to measure the lithium metal ion content of the molten salt bath 100 prior to contacting the waste glass 10 with the molten salt bath 100, the lithium metal ion content of the molten salt bath 100 after contacting waste glass 10 with the molten salt bath 100 for a duration of time, and/or the lithium metal ion content of the precipitated lithium salts 13.

Referring again to FIG. 1, the methods may include precipitating the lithium metal ions 11 from the molten salt bath 100 as precipitated lithium salt 13. In embodiments, precipitating the lithium metal ions 11 from the molten salt bath 100 may comprise adding the precipitating reagent 14 to the molten salt bath 100 after removing the residual solids 12 from the molten salt bath 100, wherein the addition of the precipitating agent 14 results in the lithium metal ions 11 precipitating from the molten salt bath 100 as precipitated lithium salt 13. In embodiments, the precipitating reagent 14 may comprise an alkali metal carbonate, an alkali metal phosphate, or a combination thereof. In embodiments, the precipitating reagent 14 may comprise sodium carbonate, sodium phosphate, or a combination thereof. In embodiments, the precipitating reagent 14 may comprise sodium carbonate, and the precipitated lithium salt 13 may comprise lithium carbonate. In embodiments, the precipitating reagent 14 may comprise sodium phosphate, and the precipitated lithium salt 13 may comprise lithium sodium phosphate, lithium phosphate, or combinations thereof.

In embodiments, precipitating the lithium metal ions 11 from the molten salt bath 100 may comprise adding the precipitating reagent 14 to the molten salt bath 100 before contacting the waste glass 10 with the molten salt bath 100, wherein the precipitating agent 14 results in the lithium metal ions 11 precipitating from the molten salt bath 100 as precipitated lithium salt 13 during extraction of the lithium metal ions from the waste glass 10. In embodiments, the molten salt bath 100 may comprise from about 0.5 wt % to about 5 wt % sodium carbonate, sodium phosphate, or both prior to contacting waste glass 10 with the molten salt bath 100. In embodiments, the molten salt bath 100 may comprise about 95 wt % sodium nitrate and about 5 wt % sodium carbonate prior to contacting waste glass 10 with the molten salt bath 100. In embodiments, the molten salt bath 100 may comprise about 98 wt % sodium nitrate and about 2 wt % sodium phosphate prior to contacting waste glass 10 with the molten salt bath 100.

Following precipitation of the lithium salts from the molten salt bath 100, the precipitated lithium salts 13 may be separated from the molten salt bath 100, such as by filtering the precipitated lithium salts 13 from the molten salt bath 100. Other solid-liquid separation processes may be used to separate the precipitated lithium salts 13 from the molten salt bath 100. Following separation of the precipitated lithium salts 13 from the molten salt bath 100, the molten salt bath 100 may be reused to extract lithium from another batch of the waste glass 10.

In embodiments, following precipitation of the lithium salts from the molten salt bath 100, the precipitated lithium salts 13 may settle in the bottom of the molten salt bath 100, and the molten salt bath 100 may be reused to extract lithium from another batch of the waste glass 10 without removing the precipitated lithium salts 13 from the molten salt bath 100. In embodiments, the molten salt bath 100 may be reused for further extraction of lithium from the waste glass 10 until the level of the precipitated lithium salts 13 in the molten salt bath 100 reaches a level equivalent to 20% of the total volume of the molten salt bath 100. Once the level of the precipitated lithium salts 13 reaches a level equivalent to 20% of the total volume of the molten salt bath 100, the precipitated lithium salts 13 may be removed from the molten salt bath 100 before the next iteration of extracting lithium from a batch of the waste glass 10.

When the residual solids 12 are removed from the molten salt bath 100, residual molten salts comprising lithium may be present on the surfaces of the pieces or particles of the residual glass 12. Upon first removing the residual solids 12 from the molted salt bath 100, the lithium from the residual molten salts may diffuse back into the particles of the residual solids 12, which may reduce the extraction efficiency of the processes disclosed herein. In embodiments, the diffusion of lithium back into the residual solids 12 can be slowed or stopped by rapidly cooling the residual solids 12, which may reduce the energy in the silica matrix of the residual solids 12, thereby reducing the diffusion rate of ions through the silica matrix.

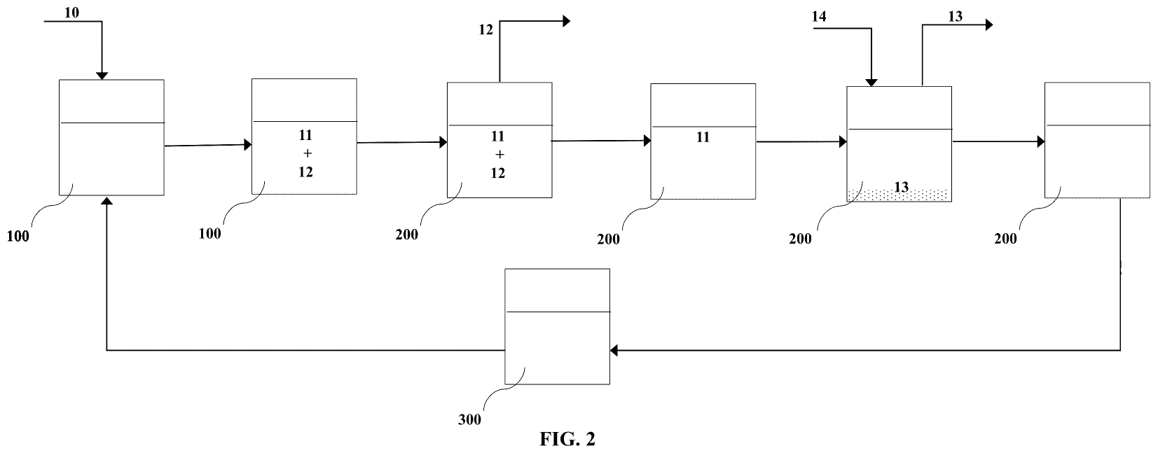

Referring now to FIG. 2, in embodiments, after the waste glass 10 is contacted with the molten salt bath 100 for a duration of time, the molten salt bath 100 and the residual solids 12 within the molten salt bath 100 may be rapidly cooled by quenching to produce a quenched salt bath 200. Following quenching of the molten salt bath 100, the residual solids 12 may be removed from the quenched salt bath 200. Quenching of the molten salt bath 100 and the residual solids 12 contained therein to produce the quenched salt bath 200 before removing the residual solids 12 may reduce or prevent diffusion of lithium back into the residual solids 12 during removing the residual solids 12 and improve the extraction efficiency of the ion exchange processes disclosed herein. Quenching the molten salt bath 100 to produce the quenched salt bath 200 prior to removing the residual solids 12 may be effective to reduce diffusion of lithium back into the residual solids when the salt-to-glass weight ratio in the molten salt bath is low, such as when the salt-to-glass ratio is from 1:1 to 10:1.

In embodiments, quenching the molten salt bath 100 and the residual solids 12 within the molten salt bath may comprise rapidly lowering the temperature of molten salt bath 100 to less than 450° C. or less than 400° C., such as from 350° C. to 450° C. In embodiments, the molten salt bath 100 and the residual solids 12 within the molten salt bath 100 may be quenched by contacting the molten salt bath 100 and residual solids 12 within the molten salt bath 100 with a cooling fluid. In embodiments, the residual solids 12 may be removed from quenched salt bath 200 after quenching. In embodiments, the lithium metal ions 11 may be precipitated from the quenched salt bath 200 as the precipitated lithium salt 13 after removing the residual solids 12 from the quenched salt bath 200. In embodiments, the precipitated lithium salt 13 may then be removed from the quenched salt bath 200. In embodiments, the quenched salt bath 200 may be reheated to a temperature greater than or equal to 450° C. to less than or equal to 600° C. to provide a regenerated molten salt bath 300. In embodiments, the regenerated molten salt bath 300 may be reused as molten salt bath 100, which can be used to extract lithium from additional waste glass 10.

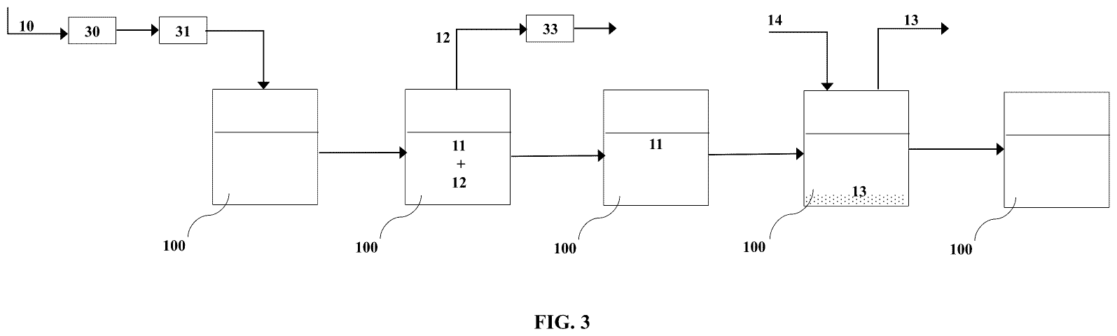

Referring now to FIG. 3, in embodiments, the residual solids 12 may be removed from the molten salt bath 100 and actively cooled to give cooled solids 33. In embodiments, actively cooling the residual solids 12 may reduce diffusion of lithium ions back into the residual solids 12. In embodiments, actively cooling the removed residual solids 12 may comprises directing a cooling medium, such as air or water, at or through the residual solids 12.

The waste glass 10 may, in embodiments, be crushed or pulverized to produce glass particles 30, which may be in the form of a powder. Crushing the waste glass 10 to produce the glass particles 30 may increase the surface area for mass transfer of lithium between the glass and the molten salt bath 100, which may increase the extraction efficiency of the ion exchange processes disclosed herein. The crushing process may produce glass particles 30 having a median particle size d50 of from about 2 microns (μm) to about 1 mm. In embodiments, the glass particles 30 may have a median particle size d50 of from about 2 μm to about 0.5 mm, from about 2 μm to about 100 μm, from about 2 μm to about 50 μm, from about 10 μm to about 1 mm, from about 10 μm to about 0.5 mm, from about 10 μm to about 100 μm, or from about 10 μm to about 50 μm.

In embodiments, the waste glass 10 and/or the crushed waste glass particles 30 can be preheated to provide a preheated glass 31. The preheating may comprise heating the waste glass 10 and/or the crushed waste glass particles 30 at a fixed temperature for a duration of time. In embodiments, the fixed temperature for preheating may be from about 200° C. to about 450° C., such as from about 250° C. to 400° C. In embodiments, the duration of preheating may be from about 5 minutes to about 30 minutes. Preheating the waste glass 10 and/or the glass particles 30 may reduce or prevent cooling of the molten salt bath 100 upon adding the waste glass 10 or the glass particles 30 to the molten salt bath 100.

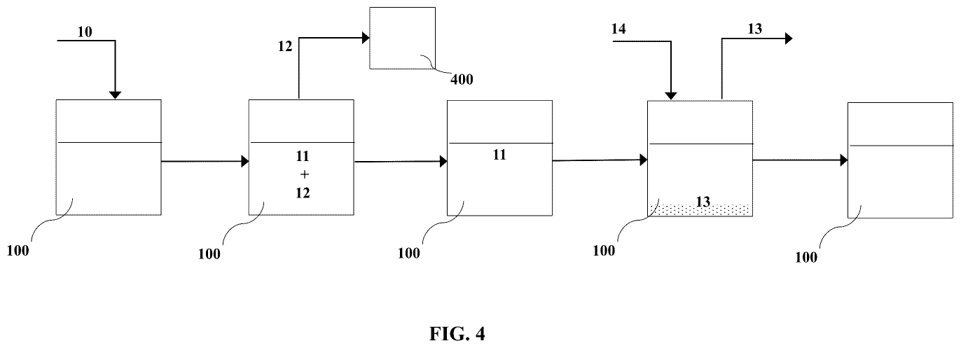

Referring now to FIG. 4, alternatively or additionally, diffusion of lithium back into the residual solids 12 may be reduced or prevented by transferring the residual solids 12 from the molten salt bath 100 to a buffering bath 400 comprising a molten salt and a very low concentration of lithium. In embodiments, the residual solids 12 may remain in the buffering bath for about 15 minutes before being removed. In embodiments, the buffering bath 400 may comprise sodium nitrate, potassium nitrate, or combinations thereof. In embodiments, the buffering bath 400 may have a concentration of lithium that is less than the concentration of lithium in the molten salt bath 100. In embodiments, prior to contacting the residual solids 12 with the buffering bath 400, the buffering bath 400 may comprise less than or equal to about 500 ppm lithium, such as from 0 ppm to about 500 ppm, from 0 ppm to about 450 ppm, from about 50 ppm to about 400 ppm, or from about 100 ppm to about 350 ppm of lithium metal ions. The buffering bath 400 may be maintained at a temperature of from about 450° C. to 600° C. In embodiments, the buffering bath 400 may be maintained at the same temperature as the molten salt bath 100.

In embodiments, contacting the residual solids 12 with the buffering bath 400 may extract residual lithium metal ions from residual solids 12 into the buffering bath 400. In embodiments, the buffering bath 400 may also comprise a precipitating reagent and the lithium salts in the buffering bath 400 may be precipitated according to the methods used to precipitate the lithium salts from the molten salt bath 100.

In embodiments, the methods disclosed herein are highly selective for lithium, such that contacting waste glass 10 with the molten salt bath 100 extracts less than or equal to about 5%, or less than or equal to about 1%, of each species other than lithium from waste glass 10. In embodiments, the precipitated lithium salt 13 may comprise greater than or equal to 95 wt %, greater than or equal to 97 wt %, or greater than or equal to 99 wt % lithium salts. In embodiments, precipitated lithium salt 13 may comprise lithium carbonate. In embodiments, precipitated lithium salt 13 may comprise lithium phosphate, lithium sodium phosphate, or combinations thereof. In embodiments, the precipitated lithium salt 13 may be used as a lithium precursor incorporated into a molten glass comprising one or a plurality of glass constituents to produce a glass comprising lithium.

As previously discussed, in embodiments of the process disclosed herein, the waste glass 10 may comprise one or a plurality of different lithium-containing glass compositions, where the glass compositions may comprise from about 30 mol % to about 85 mol % SiO₂, from about 2 mol % to about 30 mol % Al₂O₃, from 0 mol % to about 20 mol % B₂O₃, from about 2 mol % to about 20 mol % LiO₂, from 0 mol % to about 20 mol % Na₂O, from 0 mol % to about 20 mol % K₂O, from 0 mol % to about 20 mol % MgO, from 0 mol % to about 20 mol % CaO, from 0 mol % to about 10 mol % SrO, from 0 mol % to about 10 mol % BaO, from 0 mol % to about 5 mol % ZrO₂, from 0 mol % to about 5 mol % Ti₂O, and from 0 mol % to about 5 mol % Sn₂O. SiO₂, an oxide involved in the formation of glass, can function to stabilize the networking structure of glasses. The amount of SiO₂ may be limited to control the melting temperature of the glass, since the melting temperatures of pure SiO₂ and glasses with high-SiO₂ concentration are high. In embodiments, the glass compositions of the waste glass 10 may comprise from about 30 mol % to about 85 mol % SiO₂, based on the total moles of the glass composition. In embodiments, the glass compositions of the waste glass 10 may comprise from about 30 mol % to about 80 mol %, about 30 mol % to about 75 mol %, about 30 mol % to about 70 mol %, about 40 mol % to about 85 mol %, about 40 mol % to about 80 mol %, about 40 mol % to about 75 mol %, about 40 mol % to about 70 mol %, about 50 mol % to about 85 mol %, about 50 mol % to about 80 mol %, about 50 mol % to about 75 mol %, about 50 mol % to about 70 mol %, about 60 mol % to about 85 mol %, about 60 mol % to about 80 mol %, about 60 mol % to about 75 mol %, or about 60 mol % to 70 mol % SiO₂ based on the total moles of the glass compositions of the waste glass 10.

The glass compositions of the waste glass 10 may also include Al₂O₃, which may be included to provide stabilization to the glass network and also to provide improved mechanical properties and chemical durability to the glass. In embodiments, the glass compositions of the waste glass 10 may comprise from about 2 mol % to about 30 mol % Al₂O₃, based on the total moles of the glass compositions. In embodiments, glass compositions of the waste glass 10 may comprise from about 2 mol % to about 25 mol %, from about 2 mol % to about 20 mol %, from about 2 mol % to about 10 mol %, from about 2 mol % to about 5 mol %, from about 5 mol % to about 30 mol %, from about 5 mol % to about 25 mol %, from about 5 mol % to about 20 mol %, from about 5 mol % to about 10 mol %, from about 10 mol % to about 30 mol %, from about 10 mol % to about 25 mol %, from about 10 mol % to about 20 mol %, or from about 20 mol % to about 30 mol % Al₂O₃, based on the total moles of the glass compositions of the waste glass 10.

In embodiments, the glass compositions of the waste glass 10 comprise lithium oxide. The glass compositions of the waste glass 10 may comprise from about 2 to about 20 mol % Li₂O, based on the total moles of the glass compositions. In embodiments, the glass compositions of the waste 10 glass may comprise from about 2 mol % to about 15 mol %, from about 2 mol % to about 10 mol %, from about 2 mol % to about 5 mol %, from about 5 mol % to about 20 mol %, from about 5 mol % to about 15 mol %, from about 5 mol % to about 10 mol %, from about 10 mol % to about 20 mol %, or from about 10 mol % to about 15 mol % Li₂O, based on the total moles of the compositions of the glass 10.

In embodiments, the glass compositions of the waste glass 10 can include boron. In embodiments, the glass compositions of the waste glass 10 can include boron trioxide (B₂O₃). B₂O₃ may reduce a melt temperature of the glass and/or viscosity of the glass. In embodiments, the glass compositions of the waste glass 10 include may include from 0 mol % to about 20 mol % B₂O₃ based on the total moles of the compositions of the waste glass 10. In embodiments, the glass compositions of the waste glass 10 may include from 0 mol % to about 15 mol %, from 0 mol % to about 10 mol %, from 0 mol % to about 5 mol %, from 0 mol % to about 2 mol %, from about 2 mol % to about 20 mol %, from about 2 mol % to about 15 mol %, from about 2 mol % to about 10 mol %, from about 2 mol % to about 5 mol %, from about 5 mol % to about 20 mol %, from about 5 mol % to about 15 mol %, from about 5 mol % to about 10 mol %, from about 10 mol % to about 20 mol %, or from about 10 mol % to about 15 mol % B₂O₃ based on the total moles of the glass compositions of waste glass 10.

In embodiments, the glass compositions of the waste glass 10 can include non-lithium alkali metal oxides, such as Na₂O, K₂O, or both. Na₂O and K₂O are well-known in glass chemistry as “fluxes”, which refer to constituents that reduce the viscosity of glass and may be present in many types of glass. In contrast, alumina (Al₂O₃) and zirconia (ZrO₂) tend to increase the viscosity of glass. In embodiments, the glass compositions of the waste glass 10 may comprise from 0 mol % to about 40 mol %, from 0 mol % to about 30 mol %, from 0 mol % to about 25 mol %, from 0 mol % to about 20 mol %, from about 0 mol % to about 10 mol %, from about 1 mol % to about 40 mol %, from about 1 mol % to about 30 mol %, from about 1 mol % to about 25 mol %, from about 1 mol % to about 20 mol %, from about 1 mol % to about 10 mol %, from about 5 mol % to about 40 mol %, from about 5 mol % to about 30 mol %, from about 5 mol % to about 25 mol %, from about 5 mol % to about 20 mol %, from about 5 mol % to about 15 mol %, or from about 5 mol % to about 10 mol % non-lithium alkali metal oxides, based on the total moles of the compositions of the waste glass 10, where the non-lithium alkali metal oxides comprise Na₂O, K₂O, or both.

In embodiments, the glass compositions of the waste glass 10 may comprise Na₂O. In embodiments, the glass compositions of the waste glass 10 may comprise from 0 mol % to about 20 mol % Na₂O based on the total moles of the compositions of waste glass 10. In embodiments, the glass compositions of waste glass 10 may comprise from 0 mol % to about 15 mol %, from 0 mol % to about 10 mol %, from 0 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % Na₂O, based on the total moles of the glass compositions of the waste glass 10.

In embodiments, the glass compositions of the waste glass 10 may comprise K₂O. In embodiments, the glass compositions of waste glass 10 may comprise from 0 mol % to about 20 mol % K₂O based on the total moles of the glass compositions of the waste glass 10. In embodiments, the glass compositions of waste glass 10 may comprise from 0 mol % to about 15 mol %, from 0 mol % to about 10 mol %, from 0 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % K₂O, based on the total moles of the glass compositions of the waste glass 10.

In addition to non-lithium alkali metal oxides, alkaline earth metal oxides may also be present in the glass compositions of the waste glass 10. Alkaline earth metal oxides can include CaO, MgO, SrO, BaO, or combinations of these. In embodiments, the glass compositions of the waste glass 10 may have from 0 mol % (zero mol %) to about 30 mol % total RO based on the total moles of the glass compositions of the waste glass 10, where RO comprises CaO, MgO, SrO, BaO, or combinations of these. In embodiments, the glass compositions of the waste glass 10 may comprise from 0 mol % to about 25 mol %, from 0 mol % to about 20 mol %, from 0 mol % to about 15 mol %, from 0 mol % to about 10 mol %, from about 0.5 mol % to about 30 mol %, from about 0.5 mol % to about 25 mol %, from about 0.5 mol % to about 20 mol %, from about 0.5 mol % to about 15 mol %, from about 0.5 mol % to about 10 mol %, from about 5 mol % to about 30 mol %, from about 5 mol % to about 25 mol %, from about 5 mol % to about 20 mol %, from about 5 mol % to about 10 mol %, from about 10 mol % to about 30 mol %, from about 10 mol % to about 25 mol %, or from about 10 mol % to about 20 mol % total RO, based on the total moles of the glass compositions of the waste glass 10.

In embodiments, the glass compositions of the waste glass 10 may comprise MgO. In embodiments, the glass compositions of the waste glass 10 may comprise from 0 mol % to about 20 mol %, from 0 mol % to about 15 mol %, from 0 mol % to about 10 mol %, from 0 mol % to about 5 mol %, from about 0.1 mol % to about 20 mol %, from about 0.1 mol % to about 15 mol %, from about 0.1 mol % to about 10 mol %, from about 0.1 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % MgO, based on the total moles of the glass compositions of the waste glass 10.

In embodiments, the glass compositions of the waste glass 10 may comprise CaO. In embodiments, the glass compositions of the waste glass 10 may comprise from 0 mol % to about 20 mol %, from 0 mol % to about 15 mol %, from 0 mol % to about 10 mol %, from 0 mol % to about 5 mol %, from about 0.1 mol % to about 20 mol %, from about 0.1 mol % to about 15 mol %, from about 0.1 mol % to about 10 mol %, from about 0.1 mol % to about 5 mol %, from about 1 mol % to about 20 mol %, from about 1 mol % to about 15 mol %, from about 1 mol % to about 10 mol %, from about 1 mol % to about 5 mol %, from about 5 mol % to about 20 mol %, from about 5 mol % to about 15 mol %, from about 5 mol % to about 10 mol %, or from about 10 mol % to about 20 mol % CaO, based on the total moles of the glass compositions of the waste glass 10.

In embodiments, the glass compositions of the waste glass 10 may comprise SrO. In embodiments, the glass compositions of the waste glass 10 may comprise from 0 mol % to about 10 mol %, from 0 mol % to about 8 mol %, from 0 mol % to about 5 mol %, from 0 mol % to about 2 mol %, from about 0.1 mol % to about 10 mol %, from about 0.1 mol % to about 8 mol %, from about 0.1 mol % to about 5 mol %, from about 0.1 mol % to about 2 mol %, from about 1 mol % to about 10 mol %, from about 1 mol % to about 8 mol %, from about 1 mol % to about 5 mol %, from about 2 mol % to about 10 mol %, from about 2 mol % to about 8 mol %, from about 2 mol % to about 5 mol %, or from about 5 mol % to about 10 mol % SrO, based on the total moles of the glass compositions of the waste glass 10.

In embodiments, the glass compositions of waste glass 10 may comprise BaO. In embodiments, the glass compositions of the waste glass 10 may comprise from 0 mol % to about 10 mol %, from 0 mol % to about 8 mol %, from 0 mol % to about 5 mol %, from 0 mol % to about 2 mol %, from about 0.1 mol % to about 10 mol %, from about 0.1 mol % to about 8 mol %, from about 0.1 mol % to about 5 mol %, from about 0.1 mol % to about 2 mol %, from about 1 mol % to about 10 mol %, from about 1 mol % to about 8 mol %, from about 1 mol % to about 5 mol %, from about 2 mol % to about 10 mol %, from about 2 mol % to about 8 mol %, from about 2 mol % to about 5 mol %, or from about 5 mol % to about 10 mol % BaO, based on the total moles of the glass compositions of the waste glass 10.

In glass compositions, it is generally found that ZrO₂ can improve the stability of Li₂O—Al₂O₃—SiO₂ glass by significantly reducing glass devitrification during forming and lowering the liquidus temperature. At concentrations above 8 wt %, ZrSiO₄ can form a primary liquidus phase at a high temperature, which significantly lowers liquidus viscosity. Transparent glasses can be formed when the glass contains over 2 wt % ZrO₂. In embodiments, the glass compositions of the waste glass 10 may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % ZrO₂, based on the total moles of the glass compositions of the waste glass 10.

In embodiments, the glass compositions of the waste glass 10 may include one or more other glass constituents, such as but not limited to of Fe₂O₃, SnO₂, HfO₂, TiO₂, P₂O₅, Co₃O₄, Cr₂O₃, CuO, ZnO, NiO, Sb₂O₃, or combinations of these. In embodiments the glass compositions of the waste glass 10 may include TiO₂. In embodiments, the glass compositions of waste glass 10 may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % TiO₂ based on the total moles of the glass compositions. In embodiments the glass compositions of the waste glass 10 may include SnO₂. In embodiments, the glass compositions of the waste glass 10 may comprise from 0 mol % to about 5 mol %, from 0 mol % to about 3 mol %, from 0 mol % to about 2 mol %, from about 0.1 mol % to about 5 mol %, from about 0.1 mol % to about 3 mol %, from about 0.1 mol % to about 2 mol %, from about 1 mol % to about 5 mol %, from about 1 mol % to 3 mol %, from about 1 mol % to about 2 mol %, from about 2 mol % to about 5 mol %, from about 2 mol % to about 3 mol %, or from about 3 mol % to about 5 mol % SnO₂ based on the total moles of the glass compositions of the waste glass 10.

### EXAMPLES

The embodiments of the methods of the present disclosure for recovering lithium from waste glass will be further clarified by the following examples.

### Example 1

A molten salt bath was prepared according to Table 1. Five waste glass coupons were preheated at 250° C. for 15 minutes. Each coupon was 50 mm×50 mm×1 mm and the total mass of the five waste glass coupons was 30 g. The waste glass added to the molten salt bath to form a suspension. The suspension was held at 500° C. for 24 hours. The residual solids were then removed from the molten salt bath at the end of 24 hours.

An aliquot was taken from the molten salt bath just prior to adding the glass and just after removing the glass and the lithium ion concentration each aliquot was analyzed via ion exchange chromatography to determine the composition of the molten salt bath. The mass of lithium oxide extracted into the molten salt bath was calculated from the difference in lithium ion concentration in the molten salt bath before and after extraction. From this data and the known lithium content in the starting waste glass was calculated the mass of lithium oxide in the residuals solids. A lithium extraction efficiency was calculated from the mass of lithium oxide in the waste glass and the mass of lithium oxide in the residual solids. The data is presented in Table 1.

### Example 2

In Example 2, the molten salt bath comprised a precipitating agent, Na₂CO₃. The molten salt bath was prepared according to Table 1. Five waste glass coupons were preheated at 250° C. for 15 minutes. Each coupon was 50 mm×50 mm×1 mm and the total mass of the five waste glass coupons was 30 g. The waste glass was added to the molten salt bath to form a suspension. The suspension was held at 500° C. for 48 hours. After the 48 hours, the residual solids were removed from the molten salt bath. Due to the presence of Na₂CO₃, a lithium salt precipitated from the molten salt bath. The concentration of lithium in the salt precipitate was measured using ion exchange chromatography and is shown in Table 1.

An aliquot was taken from the molten salt bath just prior to adding the glass and just after removing the glass and the lithium ion concentration each aliquot was analyzed via ion exchange chromatography to determine the composition of the molten salt bath. The mass of lithium oxide extracted into the molten salt bath was calculated from the difference in lithium ion concentration in the molten salt bath before and after extraction. From this data and the known lithium content in the starting waste glass was calculated the mass of lithium oxide in the residuals solids. A lithium extraction efficiency was calculated from the mass of lithium oxide in the waste glass and the mass of lithium oxide in the residual solids. The data is presented in Table 1.

### Example 3

In Example 3, the molten salt bath comprised a precipitating agent, Na₃PO₄. The molten salt bath was prepared according to Table 1. Five waste glass coupons were preheated at 250° C. for 15 minutes. Each coupon was 50 mm×50 mm×1 mm and the total mass of the five waste glass coupons was 30 g. The waste glass added to the molten salt bath to form a suspension. The suspension was held at 500° C. for 48 hours. The residual solids were removed from the molten salt bath. The residual solids were removed from the molten salt bath.

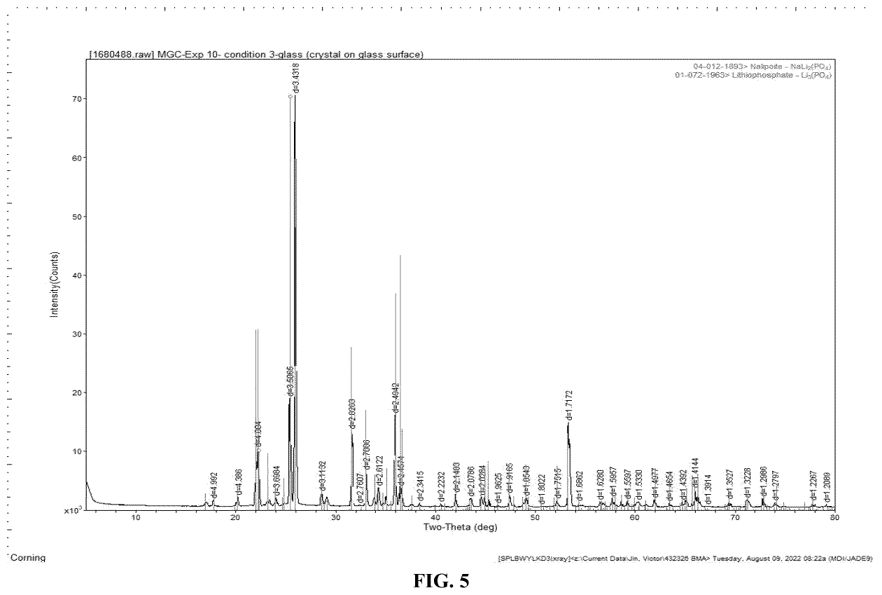

Due to the presence of Na₃PO₄, a lithium salt precipitated from the molten salt bath. The concentration of lithium in the salt precipitate was measured using ion exchange chromatography. The lithium salt was characterized by x-ray diffraction spectroscopy, which confirmed that the precipitate comprised 5 wt % Li₃PO₄ and 95 wt % NaLi₂PO₄ (see FIG. 5).

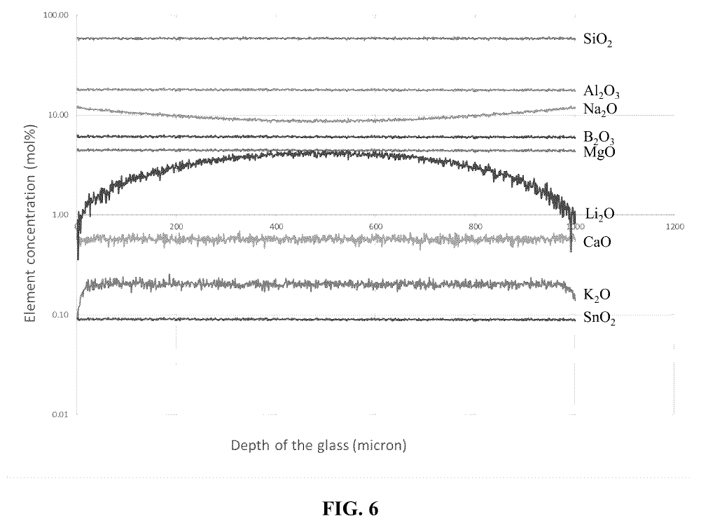

The lithium oxide concentration of the waste glass and of the residual solids was measured using electron microprobe analysis (“EMPA”; see FIG. 6). A lithium extraction efficiency was calculated based on the difference in these two concentrations and is presented in Table 1.

### Example 4

In Example 4, lithium extraction was performed on crushed waste glass particles, rather than glass coupons. The molten salt bath was prepared according to Table 1. Crushed waste glass particles (100 g of waste glass having LiO₂ content of 4.96 wt. % based on the total weight of the glass; D10=1.9 μm, D50=12 μm, and D90=33.7 μm) were added to the molten salt bath to form a suspension. The suspension was held at 500° C. for 2 hours.

The molten salt bath and residual solids were rapidly quenched using cooling air actively passed over and through the residual solids. A lithium extraction efficiency was calculated using two different methods. First, the lithium extraction rate was calculated based on the difference in lithium content of molten salt bath before and after extraction using ion exchange chromatography. Second, the lithium extraction rate was calculated based on the difference in the lithium oxide content of the crushed waste glass particles and the residual solids using inductively coupled plasma optical emission spectroscopy (“ICP-OES”), according to the methods previously discussed herein. The data is presented in Table 1.

### Example 5

In Example 5, lithium extraction was performed on crushed waste glass particles just as in Example 4, but no quick quench action was taken. Rather, the molten salt bath and residual solids were left to cool naturally at ambient conditions. The lithium extraction rate was calculated based on the difference in the lithium oxide content of the crushed waste glass particles and the residual solids using ICP-OES. The data is presented in Table 1.

### Example 6

In Example 6, lithium extraction was performed on crushed waste glass particles, but rapid quenching was performed using cooling water. The molten salt bath was prepared according to Table 1. Crushed waste glass particles (100 g of waste glass having LiO₂ content of 5.59 wt. % based on the total weight of the glass; D10=1.9 μm, D50=12 μm, and D90=33.7 μm) were added to the molten salt bath to form a suspension. The suspension was held at 500° C. for 5 hours.

The molten salt bath and residual solids together were rapidly quenched using cooling water, after which the residual solids were separated from the molten salt bath. A lithium extraction efficiency was calculated using two different methods. First, the lithium extraction rate was calculated based on the difference in lithium content of molten salt bath before and after extraction using ion exchange chromatography. Second, the lithium extraction rate was calculated based on the difference in the lithium oxide content of the crushed waste glass particles and the residual solids using ICP-OES, according to the methods disclosed herein. The data is presented in Table 1.

TABLE 1

| Example | | 1 | 2 | 3 |
|---|---|---|---|---|
| | | Extraction Conditions | | |
| Molten Salt Bath | NaNO₃ (wt %) | 100 | 95 | 98 |
| Composition | Na₂CO₃ (wt %) | 0 | 5 | 0 |
| | Na₃PO₄ (wt %) | 0 | 0 | 2 |
| | KNO₃ (wt %) | 0 | 0 | 0 |
| | Total Salt (g) | 420 | 420 | 420 |

| Salt:Glass Weight Ratio | 14:1 | 14:1 | 14:1 |
|---|---|---|---|
| Extraction Temperature (° C.) | 500 | 500 | 500 |
| Extraction Contact Duration (h) | 24 | 48 | 48 |
| Cooling | — | — | — |
| | Results | | |
| Li Content of Molten Bath | 5.9 | 7.2 | — |
| Before Extraction (ppm) | | | |
| Li Content of Molten Bath | 674.7 | 1196.2 | — |
| After Extraction (ppm) | | | |
| Mass Li₂O Extracted (g) | 0.61 | 1.06 | 1.06 |
| Mass Li₂O in Waste Glass (g) | 1.49 | 1.49 | 1.49 |
| Li Content in Precipitate (ppm) | N/A | 1307 | 4475 |
| Li Extraction Efficiency | 41.0%* | 70.8%* | 71.3%** |

| | Example | 4 | 5 | 6 |
|---|---|---|---|---|
| | | Extraction Conditions | | |
| Molten Salt Bath | NaNO₃ (wt %) | 90 | 90 | 90 |
| Composition | Na₂CO₃ (wt %) | 0 | 0 | 0 |
| | Na₃PO₄ (wt %) | 0 | 0 | 0 |
| | KNO₃ (wt %) | 10 | 10 | 10 |
| | Total Salt (g) | 500 | 500 | 500 |

| Salt:Glass Weight Ratio | 5:1 | 5:1 | 5:1 |
|---|---|---|---|
| Extraction Temperature (° C.) | 500 | 500 | 500 |
| Extraction Contact Duration (h) | 2 | 2 | 5 |
| Cooling | rapid | ambient | rapid |
| | cool air | conditions | cool |
| | quench | | water |
| | | | quench |
| | Results | | |
| Li Content of Molten Bath Before | 0 | — | 0 |
| Extraction (ppm) | | | |
| Li Content of Molten Bath After | 2472 | — | 3790 |
| Extraction (ppm) | | | |
| Mass Li₂O Extracted (g) | — | — | — |
| Mass Li₂O in Waste Glass (g) | 4.96 | 4.96 | 5.59 |
| Li Content in Precipitate (ppm) | — | — | — |
| Li Extraction Efficiency | 85.5%* | 56%** | 73%* |
| | (78%**) | | (74%**) |

*Calculation based on difference in lithium content of molten salt bath before and after extraction.
**Calculation based on difference in lithium oxide content of waste glass and residual solids.

A comparison of the data from Examples 2 and 3 to that from Example 1 illustrates that longer extraction times resulted in a more efficient lithium extraction. Also, the data in Table 1 shows that sodium phosphate was a more efficient precipitating agent than sodium carbonate, as the precipitate from Example 2 contained 1307 ppm of lithium while the precipitate from Example 3 contained 4475 ppm of lithium.

The effect of the cooling rate can be appreciated by a comparison of Examples 4-6. “Active” cooling of the molten salt bath and residual solids (i.e. rapid cooling using either cooling air or cooling water) resulted in less lithium diffusion back into the cooling residual solids than did “passive” cooling (i.e. allowing cooling to take place slowly at ambient conditions). This difference can be observed by comparing the lithium extraction efficiencies of Examples 4 and 6 to that of Example 5.

Also of note is that, for Example 6, the calculated lithium extraction efficiency based on the lithium content of the residual solids is nearly identical to the calculated lithium extraction efficiency based on the lithium content of the molten salt bath. These data further emphasize the importance of the cooling rate and suggest that the rapid quench with cooling water resulted in less lithium diffusion back into the cooling residual solids than did the rapid quench with cooling air. This is likely because when cooling water was used instead of cooling air, there was less time for lithium diffusion to take place between measuring the lithium content of the molten salt bath and measuring the lithium content of the residual solids.

The XRD data in FIG. 5 confirms that the lithium precipitate from Example 3 primarily comprises Li₂NaPO₄. The data in FIG. 5 were collected after the salt had some exposure to water, upon which some of the Li₂NaPO₄ was converted to Li₃PO₄. It was found that the lithium precipitate from Example 3 comprised 95% by weight Li₂Na(PO₄) and 5% by weight Li₃(PO₄) based on the total weight of the lithium precipitate.

The efficiency and selectivity of the extraction process disclosed herein is illustrated by FIG. 6, which shows the EMPA concentration profiles of the ions in the residual solids from Example 3. The mole percentage (“mol %”) concentration of each ion is plotted on the y-axis in a logarithmic scale. The depth of the glass from one surface in microns plotted on the x-axis.

Before extraction, the mole percentage of lithium oxide in the waste glass was about 10.7%. After 48 hours of extraction, the majority of the lithium ions (about 71.3%) were extracted from the waste glass. As shown in FIG. 6, the peak residue lithium oxide concentration in the center of the glass after extraction was less than 5 mol %.

The sodium oxide concentration significantly increased during extraction, as sodium ions replaced the lithium ions from the glass. However, the concentrations of other ions, such as silicon, aluminum, boron, potassium, magnesium, calcium, and tin ions, were not affected by the molten salt extraction.

While embodiments and examples have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

What is claimed is:

1. A method for extracting lithium metal ions from glass, the method comprising:
contacting the glass with a molten salt bath for a duration of time, wherein:
the glass comprises lithium; and
the contacting the glass with the molten salt bath for the duration of time extracts at least 40% of the lithium metal ions from the glass;
removing residual solids from the molten salt bath, wherein the residual solids comprise residual glass having a reduced concentration of lithium;
precipitating lithium metal ions from the molten salt bath to produce a solid precipitated lithium salt; and
separating the precipitated lithium salt from the molten salt bath.

2. The method of claim 1, wherein the contacting the glass with the molten salt bath for a duration of time further comprises maintaining the molten salt bath at a fixed temperature of from about 450° C. to about 600° C.

3. The method of claim 1, wherein a lithium metal ion extraction efficiency is greater than or equal to 40%.

4. The method of claim 1, wherein the residual solids, after removal from the molten salt bath, have a lithium content that is less than 50% of the lithium content in the glass before contacting with the molten salt bath.

5. The method of claim 1, further comprising crushing the glass to produce glass particles prior to contacting the glass with the molten salt bath, wherein the glass particles have a median particle size of from about 2 μm to about 1 mm.

6. The method of claim 1, further comprising, after removing the residual solids from the molten salt bath, actively cooling the residual solids, wherein:
actively cooling the residual solids comprises directing a cooling medium at or through the residual solids; and
actively cooling the residual solids reduces diffusion of lithium ions back into the residual solids.

7. The method of claim 1, further comprising, after removing the residual solids from the molten salt bath, contacting the residual solids with a buffering bath, wherein the contacting the residual solids with the buffering bath extracts residual lithium metal ions from the residual solids into the buffering bath.

8. The method of claim 7, further comprising precipitating lithium metal ions from the buffering bath to produce a precipitated lithium salt and separating the precipitated lithium salt from the buffering bath.

9. The method of claim 1, wherein the molten salt bath comprises a salt-to-glass weight ratio of greater than or equal to 1:1 and less than or equal to 10:1 and the method further comprises quenching the molten salt bath and the residual solids within the molten salt bath before removing the residual solids from the molten salt bath.

10. The method of claim 1, wherein contacting the glass with the molten salt bath extracts less than or equal to 5%, or less than or equal to 1%, of each species other than lithium from the glass.

11. The method of claim 1, wherein prior to contacting the glass with the molten salt bath, the molten salt bath comprises 95 wt. % to 100 wt. % sodium nitrate, potassium nitrate, or combinations thereof.

12. The method of claim 1, wherein precipitating the lithium metal ions from the molten salt bath comprises adding a precipitating reagent to the molten salt bath before contacting the glass with the molten salt bath or after removing the residual solids from the molten salt bath, wherein the precipitating reagent causes lithium salts to precipitate out of the molten salt bath.

13. The method of claim 12, wherein the precipitating reagent comprises an alkali metal carbonate, an alkali metal phosphate, or a combination thereof.

14. The method of claim 12, wherein, prior to contacting the glass with the molten salt bath, the molten salt bath comprises from about 0.5 wt % to about 5 wt % sodium carbonate, sodium phosphate, or combinations thereof, based on the total weight of the molten salt bath.

15. The method of claim 12, wherein the precipitating reagent is sodium carbonate and the lithium salt precipitated out of the molten salt bath comprises lithium carbonate or the precipitating reagent is sodium phosphate and the lithium salt precipitated out of the molten salt bath comprises lithium sodium phosphate.

16. The method of claim 1, further comprising preheating the glass to a preheating temperature of from about 200° C. to about 450° C. prior to contacting the glass with the molten salt bath and maintaining the glass at the preheating temperature for a duration of time from about 5 minutes to about 30 minutes.

17. The method of claim 1, wherein the contacting the glass with the molten salt bath further comprises contacting the glass with the molten salt bath for a contact duration of from about 30 minutes to about 48 hours.

18. The method of claim 1, further comprising separating the precipitated lithium salt from the molten salt bath.

19. The method of claim 18, further comprising incorporating the separated lithium salt into a molten glass comprising one or a plurality of glass constituents to produce a lithium-containing glass.

20. The method of claim 1, further comprising, after removing the residual solids from the molten salt bath, melting the residual solids and using this melted glass to make glass with little or no lithium content, wherein the glass with little or no lithium content comprises no more than about 2 wt % lithium.
